(19) United States
(12) Patent Application Publication
(10) Pub. No.: US 2026/0328534 A1
(43) Pub. Date: Oct. 22, 2026

(54) OPTICAL SYSTEM

(71) Applicant: Asia Optical Co., Inc., Taichung (TW)

(72) Inventors: Yuan-Fan Liang, Taichung (TW); Sung-Po Cheng, Taichung (TW)

(21) Appl. No.: 19/632,860

(22) Filed: Mar. 30, 2026

(30) Foreign Application Priority Data
Apr. 21, 2025 (TW) 114114982

(51) Int. Cl. F41G 1/38; G02B 7/02; G02B 15/14; G02B 25/00

(52) U.S. Cl. CPC F41G 1/38; G02B 7/021; G02B 7/023; G02B 15/145123; G02B 25/001

(57) ABSTRACT

An optical system includes an objective lens optical module, an erector lens optical module, and an eyepiece optical module, all of which are arranged in order from an object side to an image side along an optical axis. The objective lens optical module is with positive refractive power. The erector lens optical module is with positive refractive power. The eyepiece optical module is with positive refractive power. The objective lens optical module includes a first lens, a second lens, a third lens, and a fourth lens, all of which are arranged in order from the object side to the image side along the optical axis. The third lens and the fourth lens are cemented or there is no air gap between the third lens and the fourth lens. A combination of the third lens and the fourth lens is with positive refractive power.

### BACKGROUND OF THE INVENTION

### Field of the Invention

The invention relates to an optical system.

### Description of the Related Art

The current development trend of an optical system used in sight is not only toward high zoom ratio but also toward large field of view. However, the known optical system can't satisfy such requirements. Therefore, the optical system needs a new structure in order to meet the requirements of high zoom ratio and large field of view at the same time.

### BRIEF SUMMARY OF THE INVENTION

The invention provides an optical system to solve the above problems. The main purpose of the invention is to provide an optical system including an objective lens optical module, an erector lens optical module, and an eyepiece optical module, all of which are arranged in order from an object side to an image side along an optical axis. The objective lens optical module is with positive refractive power. The erector lens optical module is with positive refractive power. The eyepiece optical module is with positive refractive power. The erector lens optical module includes lens groups which move along the optical axis so that the optical system changes the zoom ratio. Therefore, even with a higher zoom ratio, a larger field of view, and a smaller displacement of 1 minute of angle (MOA), the optical system still has good optical performance.

The optical system in accordance with an exemplary embodiment of the invention includes an objective lens optical module, an erector lens optical module, and an eyepiece optical module. The objective lens optical module, the erector lens optical module, and the eyepiece optical module are arranged in order from an object side to an image side along an optical axis system. The objective lens optical module is with positive refractive power. The erector lens optical module is with positive refractive power. The eyepiece optical module is with positive refractive power. The objective lens optical module includes a first lens, a second lens, a third lens, and a fourth lens. The third lens and the fourth lens are cemented or there is no air gap between the third lens and the fourth lens. A combination of the third lens and the fourth lens is with positive refractive power. The first lens, the second lens, the third lens, and the fourth lens are arranged in order from the object side to the image side along the optical axis.

In another exemplary embodiment, the first lens is with refractive power and includes a convex surface facing the image side; the second lens is with refractive power and includes a concave surface facing the object side; the third lens is with refractive power and includes a convex surface facing the object side; the fourth lens is with refractive power; the erector lens optical module includes a first lens group, a second lens group, a third lens group, and a fourth lens group, wherein the second lens group and the third lens group move along the optical axis so that the optical system changes zoom ratio; the first lens group is with positive refractive power and includes a sixth lens, wherein the sixth lens is a meniscus lens with positive refractive power and includes a concave surface facing the object side and a convex surface facing the image side; the second lens group is with positive refractive power; the third lens group is with positive refractive power; the fourth lens group is with negative refractive power; and the first lens group, the second lens group, the third lens group, and the fourth lens group are arranged in order from the object side to the image side along the optical axis.

In yet another exemplary embodiment, the second lens group includes a seventh lens and an eighth lens; the third lens group includes a ninth lens and a tenth lens; and the fourth lens group includes an eleventh lens, a twelfth lens and a thirteenth lens.

In another exemplary embodiment, the seventh lens and the eighth lens are cemented and there is no air gap between the seventh lens and the eighth lens, and the seventh lens and the eighth lens move along the optical axis so that the optical system changes zoom ratio; the ninth lens and the tenth lens are cemented and there is no air gap between the ninth lens and the tenth lens, and the ninth lens and the tenth lens move along the optical axis so that the optical system changes zoom ratio; and the eleventh lens and the twelfth lens are cemented and there is no air gap between the eleventh lens and the twelfth lens.

In yet another exemplary embodiment, the seventh lens is a meniscus lens with positive refractive power; the eighth lens is a meniscus lens with negative refractive power; the ninth lens is a meniscus lens with negative refractive power; the tenth lens is a biconvex lens with positive refractive power and includes a convex surface facing the object side and another convex surface facing the image side; the eleventh lens is a biconcave lens with negative refractive power and includes a concave surface facing the object side and another concave surface facing the image side; the twelfth lens is a meniscus lens with positive refractive power; and the thirteenth lens is a meniscus lens with negative refractive power.

In another exemplary embodiment, the seventh lens includes a concave surface facing the object side and a convex surface facing the image side; the eighth lens includes a concave surface facing the object side and a convex surface facing the image side; the ninth lens includes a convex surface facing the object side and a concave surface facing the image side; the twelfth lens includes a convex surface facing the object side and a concave surface facing the image side; and the thirteenth lens includes a concave surface facing the object side and a convex surface facing the image side.

In yet another exemplary embodiment, the first lens is a biconvex lens with positive refractive power and further includes another convex surface facing the object side; the second lens is a meniscus lens with negative refractive power and further includes a convex surface facing the image side; the third lens is a biconvex lens with positive refractive power and further includes another convex surface facing the image side; the fourth lens is a biconcave lens with negative refractive power and includes a concave surface facing the object side and another concave surface facing the image side; the first lens and the second lens are cemented and there is no air gap between the first lens and the second lens, and a combination of the first lens and the second lens is with positive refractive power; the objective lens optical module further includes a fifth lens and a prism, wherein the fifth lens is a meniscus lens with positive refractive power; is disposed between the second lens and the third lens; and includes a convex surface facing the object side and a concave surface facing the image side; the prism is disposed between the fourth lens and the first lens group; the first lens, the second lens, the fifth lens, the third lens, the fourth lens, and the prism are arranged in order from the object side to the image side along the optical axis; the eyepiece optical module includes a fourteenth lens, a fifteenth lens, and a sixteenth lens; the fourteenth lens is a biconcave lens with negative refractive power and includes a concave surface facing the object side and another concave surface facing the image side; the fifteenth lens is a biconvex lens with positive refractive power and includes a convex surface facing the object side and another convex surface facing the image side; the sixteenth lens is a biconvex lens with positive refractive power and includes a convex surface facing the object side and another convex surface facing the image side; the fourteenth lens and the fifteenth lens are cemented and there is no air gap between the fourteenth lens and the fifteenth lens, and a combination of the fourteenth lens and the fifteenth lens is with positive refractive power; and the optical system satisfies at least one of the following conditions. 9≤fCEEL/fCEEH≤12; −0.01 mm≤fCEEH×tan(1°/60)<0 mm; 1≤|fOBJ123/fOBJ|≤2; 10≤VdEL2/NdEL2<VdEL1/NdEL1≤45; 85%≤OD2/OD3≤95%; 68%≤OD3/OD1≤75%; 10≤OD1/|OD2−OD3|≤30; 6≤OD2/(OD4−OD3)≤15; wherein fCEEL is a combined effective focal length of a combination of the erector lens optical module and the eyepiece optical module when the optical system is at low zoom ratio, fCEEH is a combined effective focal length of a combination of the erector lens optical module and the eyepiece optical module when the optical system is at high zoom ratio, fOBJ is an effective focal length of the objective lens optical module, fOBJ123 is a combined effective focal length of a combination of the lens closest to the object side, the lens second closest to the object side, and the lens third closest to the object side among the objective lens optical module, VdEL1 is an Abbe number of the lens second closest to the object side among the erector lens optical module, NdEL1 is a refractive index of the lens second closest to the object side among the erector lens optical module, VdEL2 is an Abbe number of the lens third closest to the object side among the erector lens optical module, NdEL2 is a refractive index of the lens third closest to the object side among the erector lens optical module, OD2 is a minimum effective optical diameter among the objective lens optical module, OD3 is an effective optical diameter of an object side surface of the sixth lens, OD1 is an effective optical diameter of the lens closest to the object side among the objective lens optical module, and OD4 is an effective optical diameter of an image side surface of the sixth lens.

In another exemplary embodiment, the first lens is a biconvex lens with positive refractive power and further includes another convex surface facing the object side; the second lens is a biconcave lens with negative refractive power and further includes another concave surface facing the image side; the third lens is a meniscus lens with negative refractive power and further includes a concave surface facing the image side; the fourth lens is a biconvex lens with positive refractive power and includes a convex surface facing the object side and another convex surface facing the image side; the first lens and the second lens are cemented and there is no air gap between the first lens and the second lens, and a combination of the first lens and the second lens is with negative refractive power; the objective lens optical module further includes a fifth lens and a prism, wherein the fifth lens is a biconvex lens with positive refractive power, is disposed between the object side and the first lens, and includes a convex surface facing the object side and another convex surface facing the image side; the prism is disposed between the fourth lens and the first lens group; the fifth lens, the first lens, the second lens, the third lens, the fourth lens, and the prism are arranged in order from the object side to the image side along the optical axis; the eyepiece optical module includes a fourteenth lens, a fifteenth lens, and a sixteenth lens; the fourteenth lens is a biconcave lens with negative refractive power and includes a concave surface facing the object side and another concave surface facing the image side; the fifteenth lens is a biconvex lens with positive refractive power and includes a convex surface facing the object side and another convex surface facing the image side; the sixteenth lens is a biconvex lens with positive refractive power and includes a convex surface facing the object side and another convex surface facing the image side; the fourteenth lens and the fifteenth lens are cemented and there is no air gap between the fourteenth lens and the fifteenth lens, and a combination of the fourteenth lens and the fifteenth lens is with positive refractive power; and the optical system satisfies at least one of the following conditions. 9≤fCEEL/fCEEH≤12; −0.01 mm≤fCEEH×tan(1°/60)<0 mm; 1≤|fOBJ123/fOBJ|≤2; 10≤VdEL2/NdEL2<VdEL1/NdEL1≤45; 85%≤OD2/OD3≤95%; 68%≤OD3/OD1≤75%; 10≤OD1/|OD2−OD3|≤30; 6≤OD2/(OD4−OD3)≤15; wherein fCEEL is a combined effective focal length of a combination of the erector lens optical module and the eyepiece optical module when the optical system is at low zoom ratio, fCEEH is a combined effective focal length of a combination of the erector lens optical module and the eyepiece optical module when the optical system is at high zoom ratio, fOBJ is an effective focal length of the objective lens optical module, fOBJ123 is a combined effective focal length of a combination of the lens closest to the object side, the lens second closest to the object side, and the lens third closest to the object side among the objective lens optical module, VdEL1 is an Abbe number of the lens second closest to the object side among the erector lens optical module, NdEL1 is a refractive index of the lens second closest to the object side among the erector lens optical module, VdEL2 is an Abbe number of the lens third closest to the object side among the erector lens optical module, NdEL2 is a refractive index of the lens third closest to the object side among the erector lens optical module, OD2 is a minimum effective optical diameter among the objective lens optical module, OD3 is an effective optical diameter of an object side surface of the sixth lens, OD1 is an effective optical diameter of the lens closest to the object side among the objective lens optical module, and OD4 is an effective optical diameter of an image side surface of the sixth lens.

The optical system in accordance with another exemplary embodiment of the invention includes an objective lens optical module, an erector lens optical module, and an eyepiece optical module. The objective lens optical module is with positive refractive power. The erector lens optical module is with positive refractive power. The eyepiece optical module is with positive refractive power. The objective lens optical module, the erector lens optical module, and the eyepiece optical module are arranged in order from an object side to an image side along an optical axis. The erector lens optical module includes a first lens group, a second lens group, a third lens group, and a fourth lens group; the second lens group and the third lens group move along the optical axis so that the optical system changes zoom ratio; the first lens group is with positive refractive power and includes a sixth lens, wherein the sixth lens is a meniscus lens with positive refractive power and includes a concave surface facing the object side and a convex surface facing the image side. The second lens group is with positive refractive power. The third lens group is with positive refractive power. The fourth lens group is with negative refractive power. The first lens group, the second lens group, the third lens group, and the fourth lens group are arranged in order from the object side to the image side along the optical axis.

In another exemplary embodiment, the objective lens optical module includes a first lens, a second lens, a third lens, and a fourth lens; the third lens and the fourth lens are cemented and there is no air gap between the second lens and the third lens; a combination of the third lens and the fourth lens is with positive refractive power; and the first lens, the second lens, the third lens, and the fourth lens are arranged in order from the object side to the image side along the optical axis.

In yet another exemplary embodiment, the first lens is with refractive power and includes a convex surface facing the image side; the second lens is with refractive power and includes a concave surface facing the object side; the third lens is with refractive power and includes a convex surface facing the object side; and the fourth lens is with refractive power.

In another exemplary embodiment, the second lens group includes a seventh lens and an eighth lens; the third lens group includes a ninth lens and a tenth lens; and the fourth lens group includes an eleventh lens, a twelfth lens and a thirteenth lens.

In yet another exemplary embodiment, the seventh lens and the eighth lens are cemented and there is no air gap between the seventh lens and the eighth lens, and the seventh lens and the eighth lens move along the optical axis so that the optical system changes zoom ratio; the ninth lens and the tenth lens are cemented and there is no air gap between the ninth lens and the tenth lens, and the ninth lens and the tenth lens move along the optical axis so that the optical system changes zoom ratio; and the eleventh lens and the twelfth lens are cemented and there is no air gap between the eleventh lens and the twelfth lens.

In another exemplary embodiment, the seventh lens is a meniscus lens with positive refractive power; the eighth lens is a meniscus lens with negative refractive power; the ninth lens is a meniscus lens with negative refractive power; the tenth lens is a biconvex lens with positive refractive power and includes a convex surface facing the object side and another convex surface facing the image side; the eleventh lens is a biconcave lens with negative refractive power and includes a concave surface facing the object side and another concave surface facing the image side; the twelfth lens is a meniscus lens with positive refractive power; and the thirteenth lens is a meniscus lens with negative refractive power.

In yet another exemplary embodiment, the seventh lens includes a concave surface facing the object side and a convex surface facing the image side; the eighth lens includes a concave surface facing the object side and a convex surface facing the image side; the ninth lens includes a convex surface facing the object side and a concave surface facing the image side; the twelfth lens includes a convex surface facing the object side and a concave surface facing the image side; and the thirteenth lens includes a concave surface facing the object side and a convex surface facing the image side.

In another exemplary embodiment, the first lens is a biconvex lens with positive refractive power and further includes another convex surface facing the object side; the second lens is a meniscus lens with negative refractive power and further includes a convex surface facing the image side; the third lens is a biconvex lens with positive refractive power and further includes another convex surface facing the image side; the fourth lens is a biconcave lens with negative refractive power and includes a concave surface facing the object side and another concave surface facing the image side; the first lens and the second lens are cemented and there is no air gap between the first lens and the second lens, and a combination of the first lens and the second lens is with positive refractive power; the objective lens optical module further includes a fifth lens and a prism, wherein the fifth lens is a meniscus lens with positive refractive power; is disposed between the second lens and the third lens; and includes a convex surface facing the object side and a concave surface facing the image side; the prism is disposed between the fourth lens and the first lens group; the first lens, the second lens, the fifth lens, the third lens, the fourth lens, and the prism are arranged in order from the object side to the image side along the optical axis; the eyepiece optical module includes a fourteenth lens, a fifteenth lens, and a sixteenth lens; the fourteenth lens is a biconcave lens with negative refractive power and includes a concave surface facing the object side and another concave surface facing the image side; the fifteenth lens is a biconvex lens with positive refractive power and includes a convex surface facing the object side and another convex surface facing the image side; the sixteenth lens is a biconvex lens with positive refractive power and includes a convex surface facing the object side and another convex surface facing the image side; the fourteenth lens and the fifteenth lens are cemented and there is no air gap between the fourteenth lens and the fifteenth lens, and a combination of the fourteenth lens and the fifteenth lens is with positive refractive power; and the optical system satisfies at least one of the following conditions. 9≤fCEEL/fCEEH≤12; −0.01 mm≤fCEEH×tan(1°/60)<0 mm; 1≤|fOBJ123/fOBJ|≤2; 10≤VdEL2/NdEL2<VdEL1/NdEL1≤45; 85%≤OD2/OD3≤95%; 68%≤OD3/OD1≤75%; 10≤OD1/|OD2−OD3|≤30; 6≤OD2/(OD4−OD3)≤15; wherein fCEEL is a combined effective focal length of a combination of the erector lens optical module and the eyepiece optical module when the optical system is at low zoom ratio, fCEEH is a combined effective focal length of a combination of the erector lens optical module and the eyepiece optical module when the optical system is at high zoom ratio, fOBJ is an effective focal length of the objective lens optical module, fOBJ123 is a combined effective focal length of a combination of the lens closest to the object side, the lens second closest to the object side, and the lens third closest to the object side among the objective lens optical module, VdEL1 is an Abbe number of the lens second closest to the object side among the erector lens optical module, NdEL1 is a refractive index of the lens second closest to the object side among the erector lens optical module, VdEL2 is an Abbe number of the lens third closest to the object side among the erector lens optical module, NdEL2 is a refractive index of the lens third closest to the object side among the erector lens optical module, OD2 is a minimum effective optical diameter among the objective lens optical module, OD3 is an effective optical diameter of an object side surface of the sixth lens, OD1 is an effective optical diameter of the lens closest to the object side among the objective lens optical module, and OD4 is an effective optical diameter of an image side surface of the sixth lens.

In yet another exemplary embodiment, the first lens is a biconvex lens with positive refractive power and further includes another convex surface facing the object side; the second lens is a biconcave lens with negative refractive power and further includes another concave surface facing the image side; the third lens is a meniscus lens with negative refractive power and further includes a concave surface facing the image side; the fourth lens is a biconvex lens with positive refractive power and includes a convex surface facing the object side and another convex surface facing the image side; the first lens and the second lens are cemented and there is no air gap between the first lens and the second lens, and a combination of the first lens and the second lens is with negative refractive power; the objective lens optical module further includes a fifth lens and a prism, wherein the fifth lens is a biconvex lens with positive refractive power, is disposed between the object side and the first lens, and includes a convex surface facing the object side and another convex surface facing the image side; the prism is disposed between the fourth lens and the first lens group; the fifth lens, the first lens, the second lens, the third lens, the fourth lens, and the prism are arranged in order from the object side to the image side along the optical axis; the eyepiece optical module includes a fourteenth lens, a fifteenth lens, and a sixteenth lens; the fourteenth lens is a biconcave lens with negative refractive power and includes a concave surface facing the object side and another concave surface facing the image side; the fifteenth lens is a biconvex lens with positive refractive power and includes a convex surface facing the object side and another convex surface facing the image side; the sixteenth lens is a biconvex lens with positive refractive power and includes a convex surface facing the object side and another convex surface facing the image side; the fourteenth lens and the fifteenth lens are cemented and there is no air gap between the fourteenth lens and the fifteenth lens, and a combination of the fourteenth lens and the fifteenth lens is with positive refractive power; and the optical system satisfies at least one of the following conditions: 9≤fCEEL/fCEEH≤12; −0.01 mm≤fCEEH×tan(1°/60)<0 mm; 1≤|fOBJ123/fOBJ|≤2; 10≤VdEL2/NdEL2<VdEL1/NdEL1≤45; 85%≤OD2/OD3≤95%; 68%≤OD3/OD1≤75%; 10≤OD1/|OD2−OD3|≤30; 6≤OD2/(OD4−OD3)≤15; wherein fCEEL is a combined effective focal length of a combination of the erector lens optical module and the eyepiece optical module when the optical system is at low zoom ratio, fCEEH is a combined effective focal length of a combination of the erector lens optical module and the eyepiece optical module when the optical system is at high zoom ratio, fOBJ is an effective focal length of the objective lens optical module, fOBJ123 is a combined effective focal length of a combination of the lens closest to the object side, the lens second closest to the object side, and the lens third closest to the object side among the objective lens optical module, VdEL1 is an Abbe number of the lens second closest to the object side among the erector lens optical module, NdEL1 is a refractive index of the lens second closest to the object side among the erector lens optical module, VdEL2 is an Abbe number of the lens third closest to the object side among the erector lens optical module, NdEL2 is a refractive index of the lens third closest to the object side among the erector lens optical module, OD2 is a minimum effective optical diameter among the objective lens optical module, OD3 is an effective optical diameter of an object side surface of the sixth lens, OD1 is an effective optical diameter of the lens closest to the object side among the objective lens optical module, and OD4 is an effective optical diameter of an image side surface of the sixth lens.

A detailed description is given in the following embodiments with reference to the accompanying drawings.

### BRIEF DESCRIPTION OF THE DRAWINGS

The invention can be more fully understood by reading the subsequent detailed description and examples with references made to the accompanying drawings, wherein:

FIG. 1 is a lens layout diagram of an optical system at low and high zoom ratio in accordance with a first embodiment of the invention;

FIG. 2 is a lens layout diagram of an optical system at low and high zoom ratio in accordance with the second embodiment of the invention; and

FIG. 3 is a schematic diagram of a sight at high zoom ratio which is manufactured in accordance with the first embodiment of the invention.

### DETAILED DESCRIPTION OF THE INVENTION

The following description is made for the purpose of illustrating the general principles of the invention and should not be taken in a limiting sense. The scope of the invention is best determined by reference to the appended claims.

The present invention provides an optical system including an objective lens optical module, an erector lens optical module, and an eyepiece optical module. The objective lens optical module, the erector lens optical module, and the eyepiece optical module are arranged in order from an object side to an image side along an optical axis system. The objective lens optical module is with positive refractive power. The erector lens optical module is with positive refractive power. The eyepiece optical module is with positive refractive power. The objective lens optical module includes a first lens, a second lens, a third lens, and a fourth lens. The third lens and the fourth lens are cemented or there is no air gap between the third lens and the fourth lens. A combination of the third lens and the fourth lens is with positive refractive power. The first lens, the second lens, the third lens, and the fourth lens are arranged in order from the object side to the image side along the optical axis.

The present invention provides another optical system including an objective lens optical module, an erector lens optical module, and an eyepiece optical module. The objective lens optical module, the erector lens optical module, and the eyepiece optical module are arranged in order from an object side to an image side along an optical axis system. The objective lens optical module is with positive refractive power. The erector lens optical module is with positive refractive power. The eyepiece optical module is with positive refractive power. The erector lens optical module includes a first lens group, a second lens group, a third lens group, and a fourth lens group. The second lens group and the third lens group move along the optical axis so that the optical system changes zoom ratio. The first lens group is with positive refractive power and includes a sixth lens, wherein the sixth lens is a meniscus lens with positive refractive power and includes a concave surface facing the object side and a convex surface facing the image side. The second lens group is with positive refractive power. The third lens group is with positive refractive power. The fourth lens group is with negative refractive power. The first lens group, the second lens group, the third lens group, and the fourth lens group are arranged in order from the object side to the image side along the optical axis.

Referring to Table 1 and Table 3, wherein Table 1 and Table 3 show optical specification in accordance with a first and second embodiments of the invention, respectively. The terms first, second, third, fourth, fifth, sixth, seventh, eighth, ninth, tenth, eleventh, twelfth, thirteenth, fourteenth, fifteenth, sixteenth are used in each of the embodiments are only used to distinguish components and are not used to sort or limit the number of components.

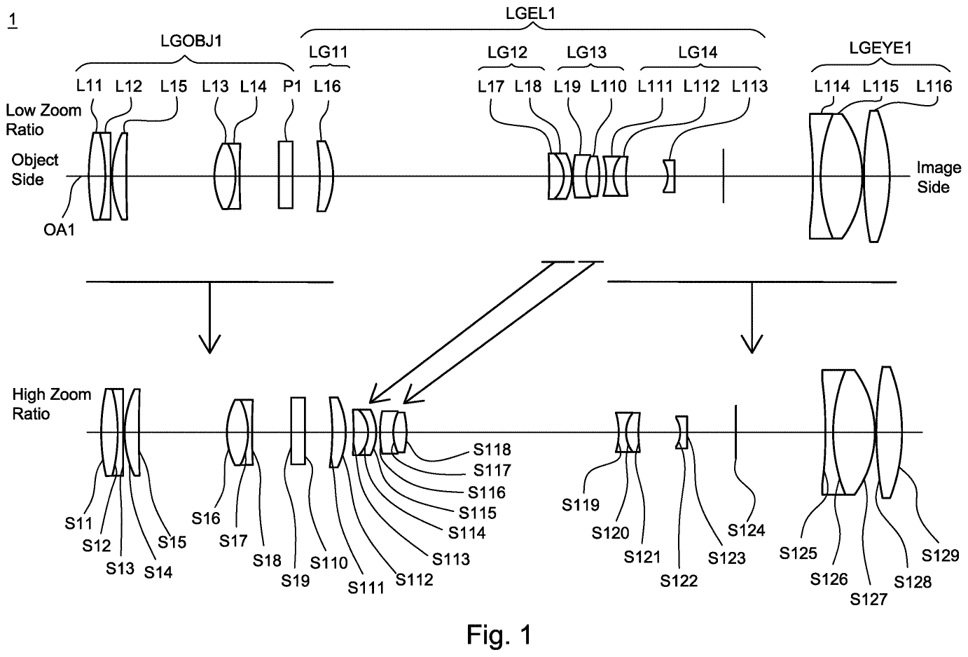

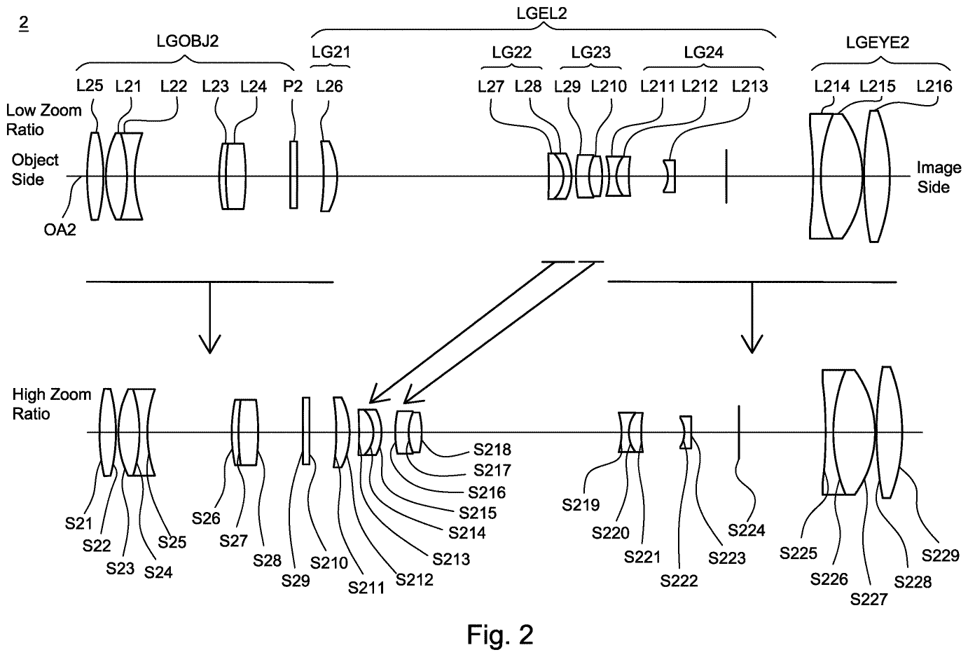

FIG. 1 and FIG. 2 are lens layout diagrams of an optical system at low and high zoom ratio in accordance with a first and a second embodiments of the invention, respectively.

The objective lens optical modules LGOBJ1, LGOBJ2 are with positive refractive power and include the first lenses L11, L21, the second lenses L12, L22, the third lenses L13, L23, the fourth lenses L14, L24, the fifth lenses L15, L25, and the prisms P1, P2, respectively. The erector lens optical modules LGEL1, LGEL2 are with positive refractive power and include the first lens groups LG11, LG21, the second lens groups LG12, LG22, the third lens groups LG13, LG23, and the fourth lens groups LG14, LG24, respectively. The first lens groups LG11, LG21 are with positive refractive power and include the sixth lenses L16, L26, respectively. The second lens groups LG12, LG22 are with positive refractive power and include the seventh lenses L17, L27 and the eighth lenses L18, L28, respectively. The third lens groups LG13, LG23 are with positive refractive power and include the ninth lenses L19, L29 and the tenth lenses L110, L210, respectively. The fourth lens groups LG14, LG24 are with negative refractive power and include the eleventh lenses L111, L211, the twelfth lenses L112, L212, and the thirteenth lenses L113, L213, respectively. The eyepiece optical modules LGEYE1, LGEYE2 are with positive refractive power and include the fourteenth lenses L114, L214, the fifteenth lenses L115, L215, and the sixteenth lenses L116, L216, respectively.

The first lenses L11, L21 are biconvex lenses with positive refractive power and made of glass material, wherein the object side surfaces S11, S23 are convex surfaces, the image side surfaces S12, S24 are convex surfaces, and both of the object side surfaces S11, S23 and image side surfaces S12, S24 are spherical surfaces. The second lenses L12, L22 are with negative refractive power and made of glass material, wherein the object side surfaces S12, S24 are concave surfaces and both of the object side surfaces S12, S24 and image side surfaces S13, S25 are spherical surfaces. The first lenses L11, L21 and the second lenses L12, L22 are cemented, respectively. There is no air gap between the first lenses L11, L21 and the second lenses L12, L22, respectively. The third lenses L13, L23 are with refractive power and made of glass material, wherein the object side surfaces S16, S26 are convex surfaces and both of the object side surfaces S16, S26 and image side surfaces S17, S27 are spherical surfaces. The fourth lenses L14, L24 are with refractive power and made of glass material, wherein both of the object side surfaces S17, S27 and image side surfaces S18, S28 are spherical surfaces. The third lenses L13 L23 and the fourth lenses L14, L24 are cemented, respectively. There is no air gap between the third lenses L13, L23 and the fourth lenses L14, L24, respectively. The combinations of the third lenses L13, L23 and the fourth lenses L14, L24 are with positive refractive power. The fifth lenses L15, L25 are with positive refractive power and made of glass material, wherein the object side surfaces S14, S21 are convex surfaces and both of the object side surfaces S14, S21 and image side surfaces S15, S22 are spherical surfaces. The prisms P1, P2 are made of glass material, wherein the object side surfaces S19, S29 are plane surfaces and the image side surfaces S110, S210 are plane surfaces. The sixth lenses L16, L26 are meniscus lenses with positive refractive power and made of glass material, wherein the object side surfaces S111, S211 are concave surfaces, the image side surfaces S112, S212 are convex surfaces, and both of the object side surfaces S111, S211 and image side surfaces S112, S212 are spherical surfaces. The seventh lenses L17, L27 are meniscus lenses with positive refractive power and made of glass material, wherein the object side surfaces S113, S213 are concave surfaces, the image side surfaces S114, S214 are convex surfaces, and both of the object side surfaces S113, S213 and image side surfaces S114, S214 are spherical surfaces. The eighth lenses L18, L28 are meniscus lenses with negative refractive power and made of glass material, wherein the object side surfaces S114, S214 are concave surfaces, the image side surfaces S115, S215 are convex surfaces, and both of the object side surfaces S114, S214 and image side surfaces S115, S215 are spherical surfaces. The seventh lenses L17, L27 and the eighth lenses L18, L28 are cemented, respectively. There is no air gap between the seventh lenses L17, L27 and the eighth lenses L18, L28, respectively. The combinations of the seventh lenses L17, L27 and the eighth lenses L18, L28 are with positive refractive power. The ninth lenses L19, L29 are meniscus lenses with negative refractive power and made of glass material, wherein the object side surfaces S 116, S216 are convex surfaces, the image side surfaces S117, S217 are concave surfaces, and both of the object side surfaces S116, S216 and image side surfaces S117, S217 are spherical surfaces. The tenth lenses L110, L210 are biconvex lenses with positive refractive power and made of glass material, wherein the object side surfaces S 117, S217 are convex surfaces, the image side surfaces S 118, S218 are convex surfaces, and both of the object side surfaces S117, S217 and image side surfaces S118, S218 are spherical surfaces. The ninth lenses L19, L29 and the tenth lenses L110, L210 are cemented, respectively. There is no air gap between the ninth lenses L19, L29 and the tenth lenses L110, L210, respectively. The combinations of the ninth lenses L19, L29 and the tenth lenses L110, L210 are with positive refractive power. The eleventh lenses L111, L211 are biconcave lenses with negative refractive power and made of glass material, wherein the object side surfaces S119, S219 are concave surfaces, the image side surfaces S120, S220 are concave surfaces, and both of the object side surfaces S119, S219 and image side surfaces S120, S220 are spherical surfaces. The twelfth lenses L112, L212 are meniscus lenses with positive refractive power and made of glass material, wherein the object side surfaces S120, S220 are convex surfaces, the image side surfaces S121, S221 are concave surfaces, and both of the object side surfaces S120, S220 and image side surface S121, S221 are spherical surfaces. The eleventh lenses L111, L211 and the twelfth lenses L112, L212 are cemented, respectively. There is no air gap between the eleventh lenses L111, L211 and the twelfth lenses L112, L212, respectively. The combinations of the eleventh lenses L111, L211 and the twelfth lenses L112, L212 are with negative refractive power. The thirteenth lenses L113, L213 are meniscus lenses with negative refractive power and made of glass material, wherein the object side surfaces S122, S222 are concave surfaces, the image side surfaces S123, S223 are convex surfaces, and both of the object side surfaces S122, S222 and image side surfaces S123, S223 are spherical surfaces. The fourteenth lenses L114, L214 are biconcave lenses with negative refractive power and made of glass material, wherein the object side surfaces S125, S225 are concave surfaces, the image side surfaces S126, S226 are concave surfaces, and both of the object side surfaces S125, S225 and image side surfaces S126, S226 are spherical surfaces. The fifteenth lenses L115, L215 are biconvex lenses with positive refractive power and made of glass material, wherein the object side surfaces S126, S226 are convex surfaces, the image side surfaces S127, S227 are convex surfaces, and both of the object side surfaces S126, S226 and image side surfaces S127, S227 are spherical surfaces. The fourteenth lenses L114, L214 and the fifteenth lenses L115, L215 are cemented, respectively. There is no air gap between the fourteenth lenses L114, L214 and the fifteenth lenses L115, L215, respectively. The combinations of the fourteenth lenses L114, L214 and the fifteenth lenses L115, L215 are with positive refractive power. The sixteenth lenses L116, L216 are biconvex lenses with positive refractive power and made of glass material, wherein the object side surfaces S128, S228 are convex surfaces, the image side surfaces S129, S229 are convex surfaces, and both of the object side surfaces S128, S228 and image side surface S129, S229 are spherical surfaces.

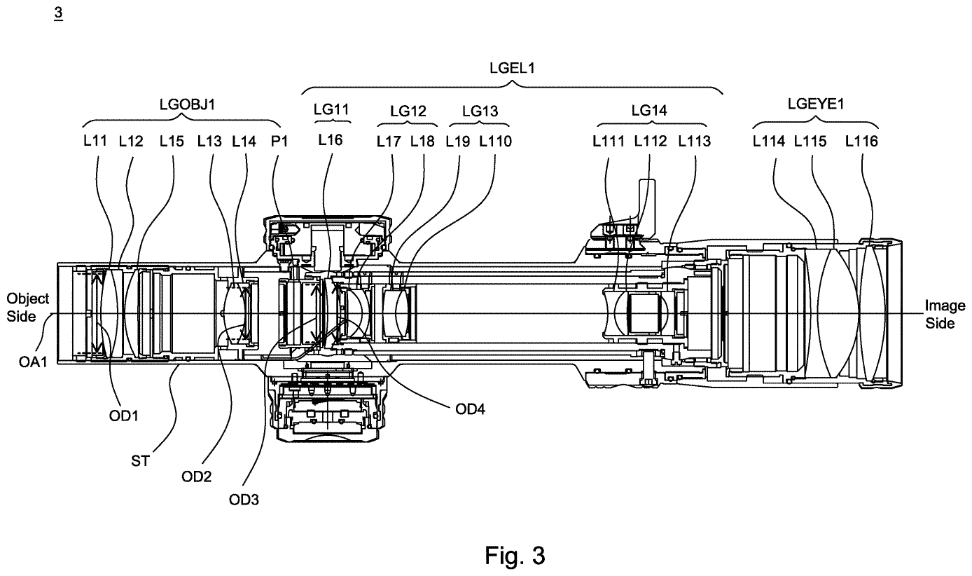

FIG. 3 is a schematic diagram of a sight at high zoom ratio which is manufactured in accordance with the first embodiment of the invention.

The sight 3 includes a tube body ST and the optical system 1. The optical system 1 is disposed inside the tube body ST and includes the objective lens optical module LGOBJ1, the erector lens optical module LGEL1, and the eyepiece optical module LGEYE1, all of which are arranged in order from the object side to the image side along the optical axis. The objective lens optical module LGOBJ1 includes the first lens L11, the second lens L12, the fifth lens L15, the third lens L13, the fourth lens L14, and the prism P1, all of which are arranged in order from the object side to the image side along the optical axis. The erector lens optical module LGEL1 includes the first lens group LG11, the second lens group LG12, the third lens group LG13, and the fourth lens group LG14, all of which are arranged in order from the object side to the image side along the optical axis. The first lens group LG11 includes the sixth lens L16 which can also be considered as a condenser lens. The second lens group LG12 includes the seventh lens L17 and the eighth lens L18, both of which are arranged in order from the object side to the image side along the optical axis. The third lens group LG13 includes the ninth lens L19 and the tenth lens L110, both of which are arranged in order from the object side to the image side along the optical axis. The fourth lens group LG14 includes the eleventh lens L111, the twelfth lens L112, and the thirteenth lens L113, all of which are arranged in order from the object side to the image side along the optical axis. The eyepiece optical module LGEYE1 includes the fourteenth lens L114, the fifteenth lens L115, and the sixteenth lens L116, all of which are arranged in order from the object side to the image side along the optical axis. OD1 is the effective optical diameter of the object side surface of the lens L11 which is closest to the object side among the objective lens optical module LGOBJ1. OD2 is the smallest effective optical diameter among the objective lens optical module LGOBJ1, OD3 is the effective optical diameter of the object side surface of sixth lens (condenser lens) L16, and OD4 is the effective optical diameter of the image side surface of sixth lens (condenser lens) L16. The aforementioned effective optical diameters OD1, OD2, OD3, and OD4 are limited by the inner diameter of the tube body ST, for example, the inner diameter of the tube body ST located between the object side surface S11 (the object side surface of the lens L11 closest to the object side) and the object side is not a fixed value, but has different inner diameters. In this situation, based on the characteristic of light propagation, the effective optical diameter OD1 will be equivalent to the minimum inner diameter of the tube body ST located between the object side surface S11 and the object side.

In addition, the optical system 1, 2 satisfy at least one of the following conditions:

9≤fCEEL/fCEEH≤12; (1)

−0.01 mm≤fCEEH×tan(1°/60)<0 mm; (2)

1≤|fOBJ123/fOBJ|≤2; (3)

10≤VdEL2/NdEL2<VdEL1/NdEL1≤45; (4)

85%≤OD2/OD3≤95%; (5)

68%≤OD3/OD1≤75%; (6)

10≤OD1/|OD2−OD3|≤30; (7)

6≤OD2/(OD4−OD3)≤15; (8)
wherein fCEEL is a combined effective focal length of the combinations of the erector lens optical modules LGEL1, LGEL2 and the eyepiece optical modules LGEYE1, LGEYE2 when the optical systems 1, 2 are at low zoom ratio for the first to second embodiments, fCEEH is a combined effective focal length of the combinations of the erector lens optical modules LGEL1, LGEL2 and the eyepiece optical modules LGEYE1, LGEYE2 when the optical systems 1, 2 are at high zoom ratio for the first to second embodiments, fOBJ is an effective focal length of the objective lens optical modules LGOBJ1, LGOBJ2 for the first to second embodiments, fOBJ123 is a combined effective focal length of the combinations of the lenses L11, L25 which are closest to the object side, the lenses L12, L21 which are second closest to the object side, and the lenses L15, L22 which are third closest to the object side among the objective lens optical modules LGOBJ1, LGOBJ2 for the first to second embodiments, VdEL1 is an Abbe number of the lenses L17, L27 which are second closest to the object side among the erector lens optical modules LGEL1, LGEL2 for the first to second embodiments, NdEL1 is a refractive index of the lenses L17, L27 which are second closest to the object side among the erector lens optical modules LGEL1, LGEL2 for the first to second embodiments, VdEL2 is an Abbe number of the lenses L18, L28 which are third closest to the object side among the erector lens optical modules LGEL1, LGEL2 for the first to second embodiments, NdEL2 is a refractive index of the lenses L18, L28 which are third closest to the object side among the erector lens optical modules LGEL1, LGEL2 for the first to second embodiments, OD2 is a minimum effective optical diameter among the objective lens optical modules LGOBJ1, LGOBJ2 for the first to second embodiments, OD3 is an effective optical diameter of the object side surfaces S111, S211 of the sixth lenses (condenser lens) L16, L26 for the first to second embodiments, OD1 is an effective optical diameter of the lenses L11, L25 which are closest to the object side among the objective lens optical modules LGOBJ1, LGOBJ2 for the first to second embodiments, and OD4 is an effective optical diameter of the image side surfaces S112, S212 of the sixth lenses (condenser lens) L16, L26 for the first to second embodiments. The aforementioned effective optical diameters OD1, OD2, OD3, and OD4 are limited by the inner diameter of the tube body ST, for example, the inner diameter of the tube body ST located between the object side surfaces S11, S21 of the lenses L11, L25 which are closest to the object side and the object side is not a fixed value, but has different inner diameters. In this situation, based on the characteristic of light propagation, the effective optical diameter OD1 will be equivalent to the minimum inner diameter of the tube body ST located between the object side surfaces S11, S21 and the object side. With the optical systems 1, 2 satisfying at least one of the above conditions (1)-(8), the field of view can be effectively increased, the displacement of 1 minute of angle (MOA) can be effectively decreased, the aberration can be effectively corrected, and the chromatic aberration can be effectively corrected.

A detailed description of an optical system in accordance with a first embodiment of the invention is as follows. Referring to FIG. 1, FIG. 1 is a lens layout diagram of an optical system at low and high zoom ratio in accordance with a first embodiment of the invention. The optical system 1 includes an objective lens optical module LGOBJ1, an erector lens optical module LGEL1, and an eyepiece optical module LGEYE1, all of which are arranged in order from an object side to an image side along an optical axis OA1. The objective lens optical module LGOBJ1 includes a first lens L11, a second lens L12, a fifth lens L15, a third lens L13, a fourth lens L14, and a prism P1, all of which are arranged in order from the object side to the image side along the optical axis OA1. The erector lens optical module LGEL1 includes a first lens group LG11, a second lens group LG12, a third lens group LG13, and a fourth lens group LG14, all of which are arranged in order from the object side to the image side along the optical axis OA1. The first lens group LG11 includes a sixth lens L16. The second lens group LG12 includes a seventh lens L17 and an eighth lens L18. The third lens group LG13 includes a ninth lens L19 and a tenth lens L110. The fourth lens group LG14 includes an eleventh lens L111, a twelfth lens L112, and a thirteenth lens L113. The eyepiece optical module LGEYE1 includes a fourteenth lens L114, a fifteenth lens L114, and a sixteenth lens L116, all of which are arranged in order from the object side to the image side along the optical axis OA1. The first lens L11, the second lens L12, the fifth lens L15, the third lens L13, the fourth lens L14, the prism P1, the sixth lens L16, the seventh lens L17, the eighth lens L18, the ninth lens L19, the tenth lens L110, the eleventh lens L111, the twelfth lens L112, the thirteenth lens L113, the fourteenth lens L114, the fifteenth lens L115, and the sixteenth lens L116 are arranged in order from the object side to the image side along the optical axis OA1. The seventh lens L17, the eighth lens L18, the ninth lens L19, and the tenth lens L110 move along the optical axis OA1 so that the interval between the sixth lens L16 and the seventh lens L17, the interval between the eighth lens L18 and the ninth lens L19, and the interval between the tenth lens L110 and the eleventh lens L111 are changed, thereby changing the zoom ratio of the optical system 1. The optical system 1 of the first embodiment has a maximum zoom ratio of 10 times, that is, a minimum zoom ratio of 1 time and a maximum zoom ratio of 10 times. In operation, the light from the object side first passes through the objective lens optical module LGOBJ1, forms an inverted image on the first image plane (not shown), then passes through the erector lens optical module LGEL1 to form an erect image on the second image plane S124, and finally passes through the eyepiece optical module LGEYE1 and imaged on human's eyes. In other words, the boundary between the objective lens optical module LGOBJ1 and the erector lens optical module LGEL1 is separated by the first image plane and the boundary between the erector lens optical module LGEL1 and the eyepiece optical module LGEYE1 is separated by the second image plane S124.

According to the foregoing, wherein: the second lens L12 is a meniscus lens, wherein the image side surface S13 is a convex surface; a combination of the first lens L11 and the second lens L12 is with positive refractive power; the fifth lens L15 is a meniscus lens, wherein the image side surface S15 is a concave surface; the third lens L13 is a biconvex lens with positive refractive power, wherein the image side surface is a convex surface; the fourth lens L14 is a biconcave lens with negative refractive power, wherein the object side surface S17 is a concave surface and the image side surface S18 is a concave surface; with the above design of the objective lens optical module LGOBJ1, the erector lens optical module LGEL1, the eyepiece optical module LGEYE1, and at least one of the conditions (1)-(8) is satisfied, the optical system 1 can have an effective increased field of view, an effective decreased the displacement of 1 minute of angle (MOA), an effective corrected aberration, and an effective corrected chromatic aberration.

Table 1 shows the optical specification of the optical system 1 in FIG. 1.

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S11 | 51.967 | 5 | 1.497 | 81.61 | 48.021 | L11 |
| S12 | −42.726 | 1.5 | 1.905 | 35.04 | −49.616 | L12 |
| S13 | −891.935 | 0.5 | | | | |
| S14 | 27.761 | 4 | 1.517 | 52.43 | 57.051 | L15 |
| S15 | 443.42 | 25.42 | | | | |
| S16 | 18.113 | 6.35 | 1.516 | 64.14 | 18.654 | L13 |
| S17 | −18.113 | 1 | 1.835 | 42.71 | −19.977 | L14 |
| S18 | 215.56 | 11.35547 | | | | |
| S19 | ∞ | 4 | 1.516 | 64.14 | | P1 |
| S110 | ∞ | 8 | | | | |
| S111 | −56.574 | 3.83 | 1.804 | 46.53 | 40.557 | L16 |
| S112 | −21.309 | 61.47 (Low Zoom Ratio) | | | | |
| | | 2.17 (High Zoom Ratio) | | | | |
| S113 | −97.303 | 4.24 | 1.516 | 64.14 | 17.67 | L17 |
| S114 | −8.465 | 2.2 | 1.805 | 25.43 | −35.53 | L18 |
| S115 | −13.416 | 1.50 (Low Zoom Ratio) | | | | |
| | | 3.89 (High Zoom Ratio) | | | | |
| S116 | 30.606 | 3.81 | 1.738 | 32.33 | −32.784 | L19 |
| S117 | 12.798 | 3.8 | 1.516 | 64.14 | 17.052 | L110 |
| S118 | −25.36 | 2.07 (Low Zoom Ratio) | | | | |
| | | 58.99 (High Zoom Ratio) | | | | |
| S119 | −17.535 | 2 | 1.516 | 64.14 | −10.855 | L111 |
| S120 | 8.558 | 3.74 | 1.871 | 40.73 | 11.404 | L112 |
| S121 | 49.36 | 12.07 | | | | |
| S122 | −7.327 | 2 | 1.497 | 81.61 | −15.207 | L113 |
| S123 | −261.47 | 14.11 | | | | |
| S124 | ∞ | 26.15 | | | | The |
| | | | | | | Second |
| | | | | | | Image |
| | | | | | | Plane |
| S125 | −97.421 | 2 | 1.74 | 28.3 | −42.857 | L114 |
| S126 | 47.431 | 12.21 | 1.516 | 64.14 | 37.61 | L115 |
| S127 | −29.998 | 0.3 | | | | |
| S128 | 101.01 | 7.5 | 1.589 | 61.14 | 60.463 | L116 |
| S129 | −53.508 | 90 | | | | |

Table 2 shows the parameters and condition values for conditions (1)-(8) in accordance with the first embodiment of the invention. It can be seen from Table 2 that the optical system 1 of the first embodiment satisfies the conditions (1)-(8).

TABLE 2

| | | | | | |
|---|---|---|---|---|---|
| fCEEL | −42.392 mm | fCEEH | −3.881 mm | fOBJ | 41.163 mm |
| fOBJ123 | 54.785 mm | VdEL1 | 64.14 | NdVL1 | 1.516 |
| VdEL2 | 25.43 | NdVL2 | 1.805 | OD2 | 15.4 mm |
| OD3 | 17 mm | OD1 | 24 mm | OD4 | 18.4 mm |

| | | | |
|---|---|---|---|
| fCEEL/fCEEH | 10.923 | IfOBJ123/ | 1.3309 |
| | | fOBJ\| | |
| fCEEH × tan(1°/60) | −0.0011 mm | VdEL2/ | 14.08 |
| | | NdEL2 | |
| VdEL1/NdEL1 | 42.3 | | |
| OD2/OD3 | 91% | OD3/OD1 | 71% |
| OD1/\|OD2-OD3\| | 15 | OD2/ | 11 |
| | | (OD4- | |
| | | OD3) | |

A detailed description of an optical system in accordance with a second embodiment of the invention is as follows. Referring to FIG. 2, FIG. 2 is a lens layout diagram of an optical system at low and high zoom ratio in accordance with a second embodiment of the invention. The optical system 2 includes an objective lens optical module LGOBJ2, an erector lens optical module LGEL2, and an eyepiece optical module LGEYE2, all of which are arranged in order from an object side to an image side along an optical axis OA2. The objective lens optical module LGOBJ2 includes a fifth lens L25, a first lens L21, a second lens L22, a third lens L23, a fourth lens L24, and a prism P2, all of which are arranged in order from the object side to the image side along the optical axis OA2. The erector lens optical module LGEL2 includes a first lens group LG21, a second lens group LG22, a third lens group LG23, and a fourth lens group LG24, all of which are arranged in order from the object side to the image side along the optical axis OA2. The first lens group LG21 includes a sixth lens L26. The second lens group LG22 includes a seventh lens L27 and an eighth lens L28. The third lens group LG23 includes a ninth lens L29 and a tenth lens L210. The fourth lens group LG24 includes an eleventh lens L211, a twelfth lens L212, and a thirteenth lens L213. The eyepiece optical module LGEYE2 includes a fourteenth lens L214, a fifteenth lens L215, and a sixteenth lens L216, all of which are arranged in order from the object side to the image side along the optical axis OA2. The fifth lens L25, the first lens L21, the second lens L22, the third lens L23, the fourth lens L24, the prism P2, the sixth lens L26, the seventh lens L27, the eighth lens L28, the ninth lens L29, the tenth lens L210, the eleventh lens L211, the twelfth lens L212, the thirteenth lens L213, the fourteenth lens L214, the fifteenth lens L215, and the sixteenth lens L216 are arranged in order from the object side to the image side along the optical axis OA2. The seventh lens L27, the eighth lens L28, the ninth lens L29, and the tenth lens L210 move along the optical axis OA2 so that the interval between the sixth lens L26 and the seventh lens L27, the interval between the eighth lens L28 and the ninth lens L29, and the interval between the tenth lens L210 and the eleventh lens L211 are changed, thereby changing the zoom ratio of the optical system 2. The optical system 2 of the second embodiment has a maximum zoom ratio of 10 times, that is, a minimum zoom ratio of 1 time and a maximum zoom ratio of 10 time. In operation, the light from the object side first passes through the objective lens optical module LGOBJ2, forms an inverted image on the first image plane (not shown), then passes through the erector lens optical module LGEL2 to form an erect image on the second image plane S224, and finally passes through the eyepiece optical module LGEYE2 and imaged on human's eyes. In other words, the boundary between the objective lens optical module LGOBJ2 and the erector lens optical module LGEL2 is separated by the first image plane and the boundary between the erector lens optical module LGEL2 and the eyepiece optical module LGEYE2 is separated by the second image plane S224.

According to the foregoing, wherein: the second lens L22 is a biconcave lens, wherein the image side surface S25 is a concave surface; a combination of the first lens L21 and the second lens L22 is with negative refractive power; the fifth lens L25 is a biconvex lens, wherein the image side surface S22 is a convex surface; the third lens L23 is a meniscus lens with negative refractive power, wherein the image side surface S27 is a concave surface; the fourth lens L24 is a biconvex lens with positive refractive power, wherein the object side surface S27 is a convex surface and the image side surface S28 is a convex surface; with the above design of the objective lens optical module LGOBJ2, the erector lens optical module LGEL2, the eyepiece optical module LGEYE2, and at least one of the conditions (1)-(8) is satisfied, the optical system 2 can have an effective increased field of view, an effective decreased the displacement of 1 minute of angle (MOA), an effective corrected aberration, and an effective corrected chromatic aberration.

Table 3 shows the optical specification of the optical system 2 in FIG. 2.

TABLE 3

| | Radius of | | | | Effective | |
|---|---|---|---|---|---|---|
| Surface | Curvature | Thickness | | | Focal Length | |
| Number | (mm) | (mm) | Nd | Vd | (mm) | Remark |
| S21 | 48.621 | 5 | 1.516 | 64.14 | 47.924 | L25 |
| S22 | −48.621 | 1 | | | | |
| S23 | 25.447 | 6 | 1.497 | 81.61 | 31.955 | L21 |
| S24 | −38.944 | 2.5 | 1.883 | 40.77 | −21.667 | L22 |
| S25 | 38.736 | 24.392 | | | | |
| S26 | 88.46 | 2 | 1.847 | 23.88 | −119.569 | L23 |
| S27 | 46.719 | 6 | 1.874 | 35.26 | 27.578 | L24 |
| S28 | −46.806 | 12.8105 | | | | |
| S29 | ∞ | 2 | 1.516 | 64.14 | | P2 |
| S210 | ∞ | 8 | | | | |
| S211 | −56.574 | 3.83 | 1.804 | 46.53 | 40.557 | L26 |
| S212 | −21.309 | 61.47(Low Zoom Ratio) | | | | |
| | | 2.17(High Zoom Ratio) | | | | |
| S213 | −97.303 | 4.24 | 1.516 | 64.14 | 17.67 | L27 |
| S214 | −8.465 | 2.2 | 1.805 | 25.43 | −35.53 | L28 |
| S215 | −13.416 | 1.50 (Low Zoom Ratio) | | | | |
| | | 3.89 (High Zoom Ratio) | | | | |
| S216 | 30.606 | 3.81 | 1.738 | 32.33 | −32.784 | L29 |
| S217 | 12.798 | 3.8 | 1.516 | 64.14 | 17.052 | L210 |
| S218 | −25.36 | 2.07 (Low Zoom Ratio) | | | | |
| | | 58.99 (High Zoom Ratio) | | | | |
| S219 | −17.535 | 2 | 1.516 | 64.14 | −10.855 | L211 |
| S220 | 8.558 | 3.74 | 1.871 | 40.73 | 11.404 | L212 |
| S221 | 49.36 | 12.07 | | | | |
| S222 | −7.327 | 2 | 1.497 | 81.61 | −15.207 | L213 |
| S223 | −261.47 | 14.11 | | | | |
| S224 | ∞ | 26.15 | | | | The |
| | | | | | | Second |
| | | | | | | Image |
| | | | | | | Plane |
| S225 | −97.421 | 2 | 1.74 | 28.3 | −42.857 | L214 |
| S226 | 47.431 | 12.21 | 1.516 | 64.14 | 37.61 | L215 |
| S227 | −29.998 | 0.3 | | | | |
| S228 | 101.01 | 7.5 | 1.589 | 61.14 | 60.463 | L216 |
| S229 | −53.508 | 90 | | | | |

Table 4 shows the parameters and condition values for conditions (1)-(8) in accordance with the second embodiment of the invention. It can be seen from Table 4 that the optical system 2 of the second embodiment satisfies the conditions (1)-(8).

TABLE 4

| | | | | | |
|---|---|---|---|---|---|
| fCEEL | −42.392 mm | fCEEH | −3.881 mm | fOBJ | 41.157 mm |
| fOBJ123 | 68.805 mm | VdEL1 | 64.14 | NdVL1 | 1.516 |
| VdEL2 | 25.43 | NdVL2 | 1.805 | OD2 | 15.4 mm |
| OD3 | 17 mm | OD1 | 24 mm | OD4 | 18.4 mm |

| | | | |
|---|---|---|---|
| fCEEL/fCEEH | 10.923 | \|fOBJ123/ | 1.672 |
| | | fOBJ\| | |
| fCEEH × tan(1°/60) | −0.0011 mm | VdEL2/ | 14.08 |
| | | NdEL2 | |
| VdEL1/NdEL1 | 42.3 | | |
| OD2/OD3 | 91% | OD3/OD1 | 71% |
| OD1/\|OD2-OD3\| | 15 | OD2/ | 11 |
| | | (OD4- | |
| | | OD3) | |

While the invention has been described by way of example and in terms of the preferred embodiment(s), it is to be understood that the invention is not limited thereto. On the contrary, it is intended to cover various modifications and similar arrangements and procedures, and the optical system of the appended claims therefore should be accorded the broadest interpretation so as to encompass all such modifications and similar arrangements and procedures.

What is claimed is:

1. An optical system comprising:
an objective lens optical module which is with positive refractive power;
an erector lens optical module which is with positive refractive power; and
an eyepiece optical module which is with positive refractive power;
wherein the objective lens optical module, the erector lens optical module, and the eyepiece optical module are arranged in order from an object side to an image side along an optical axis;
wherein the objective lens optical module comprises a first lens, a second lens, a third lens, and a fourth lens; the third lens and the fourth lens are cemented or there is no air gap between the third lens and the fourth lens; and a combination of the third lens and the fourth lens is with positive refractive power;
wherein the first lens, the second lens, the third lens, and the fourth lens are arranged in order from the object side to the image side along the optical axis.

2. The optical system as claimed in claim 1, wherein:
the first lens is with refractive power and comprises a convex surface facing the image side;
the second lens is with refractive power and comprises a concave surface facing the object side;
the third lens is with refractive power and comprises a convex surface facing the object side;
the fourth lens is with refractive power;
the erector lens optical module comprises a first lens group, a second lens group, a third lens group, and a fourth lens group, wherein the second lens group and the third lens group move along the optical axis so that the optical system changes zoom ratio; the first lens group is with positive refractive power and comprises a sixth lens, wherein the sixth lens is a meniscus lens with positive refractive power and comprises a concave surface facing the object side and a convex surface facing the image side;
the second lens group is with positive refractive power;
the third lens group is with positive refractive power;
the fourth lens group is with negative refractive power; and
the first lens group, the second lens group, the third lens group, and the fourth lens group are arranged in order from the object side to the image side along the optical axis.

3. The optical system as claimed in claim 2, wherein:
the second lens group comprises a seventh lens and an eighth lens;
the third lens group comprises a ninth lens and a tenth lens; and
the fourth lens group comprises an eleventh lens, a twelfth lens and a thirteenth lens.

4. The optical system as claimed in claim 3, wherein:
the seventh lens and the eighth lens are cemented and there is no air gap between the seventh lens and the eighth lens, and the seventh lens and the eighth lens move along the optical axis so that the optical system changes zoom ratio;
the ninth lens and the tenth lens are cemented and there is no air gap between the ninth lens and the tenth lens, and the ninth lens and the tenth lens move along the optical axis so that the optical system changes zoom ratio; and
the eleventh lens and the twelfth lens are cemented and there is no air gap between the eleventh lens and the twelfth lens.

5. The optical system as claimed in claim 4, wherein:
the seventh lens is a meniscus lens with positive refractive power;
the eighth lens is a meniscus lens with negative refractive power;
the ninth lens is a meniscus lens with negative refractive power;
the tenth lens is a biconvex lens with positive refractive power and comprises a convex surface facing the object side and another convex surface facing the image side;
the eleventh lens is a biconcave lens with negative refractive power and comprises a concave surface facing the object side and another concave surface facing the image side;
the twelfth lens is a meniscus lens with positive refractive power; and
the thirteenth lens is a meniscus lens with negative refractive power.

6. The optical system as claimed in claim 5, wherein:
the seventh lens comprises a concave surface facing the object side and a convex surface facing the image side;
the eighth lens comprises a concave surface facing the object side and a convex surface facing the image side;
the ninth lens comprises a convex surface facing the object side and a concave surface facing the image side;
the twelfth lens comprises a convex surface facing the object side and a concave surface facing the image side; and
the thirteenth lens comprises a concave surface facing the object side and a convex surface facing the image side.

7. The optical system as claimed in claim 5, wherein:
the first lens is a biconvex lens with positive refractive power and further comprises another convex surface facing the object side;
the second lens is a meniscus lens with negative refractive power and further comprises a convex surface facing the image side;
the third lens is a biconvex lens with positive refractive power and further comprises another convex surface facing the image side;
the fourth lens is a biconcave lens with negative refractive power and comprises a concave surface facing the object side and another concave surface facing the image side;
the first lens and the second lens are cemented and there is no air gap between the first lens and the second lens, and a combination of the first lens and the second lens is with positive refractive power;
the objective lens optical module further comprises a fifth lens and a prism, wherein the fifth lens is a meniscus lens with positive refractive power;
is disposed between the second lens and the third lens; and comprises a convex surface facing the object side and a concave surface facing the image side;
the prism is disposed between the fourth lens and the first lens group;
the first lens, the second lens, the fifth lens, the third lens, the fourth lens, and the prism are arranged in order from the object side to the image side along the optical axis;
the eyepiece optical module comprises a fourteenth lens, a fifteenth lens, and a sixteenth lens;
the fourteenth lens is a biconcave lens with negative refractive power and comprises a concave surface facing the object side and another concave surface facing the image side;
the fifteenth lens is a biconvex lens with positive refractive power and comprises a convex surface facing the object side and another convex surface facing the image side;
the sixteenth lens is a biconvex lens with positive refractive power and comprises a convex surface facing the object side and another convex surface facing the image side;
the fourteenth lens and the fifteenth lens are cemented and there is no air gap between the fourteenth lens and the fifteenth lens, and a combination of the fourteenth lens and the fifteenth lens is with positive refractive power; and
the optical system satisfies at least one of following conditions:
9≤fCEEL/fCEEH≤12;
−0.01 mm≤fCEEH×tan(1°/60)<0 mm;
1≤|fOBJ123/fOBJ|≤2;
10≤VdEL2/NdEL2<VdEL1/NdEL1≤45;
85%≤OD2/OD3≤95%;
68%≤OD3/OD1≤75%;
10≤OD1/|OD2−OD33≤30;
6≤OD2/(OD4−OD3)≤15;
wherein fCEEL is a combined effective focal length of a combination of the erector lens optical module and the eyepiece optical module when the optical system is at low zoom ratio, fCEEH is a combined effective focal length of a combination of the erector lens optical module and the eyepiece optical module when the optical system is at high zoom ratio, fOBJ is an effective focal length of the objective lens optical module, fOBJ123 is a combined effective focal length of a combination of the lens closest to the object side, the lens second closest to the object side, and the lens third closest to the object side among the objective lens optical module, VdEL1 is an Abbe number of the lens second closest to the object side among the erector lens optical module, NdEL1 is a refractive index of the lens second closest to the object side among the erector lens optical module, VdEL2 is an Abbe number of the lens third closest to the object side among the erector lens optical module, NdEL2 is a refractive index of the lens third closest to the object side among the erector lens optical module, OD2 is a minimum effective optical diameter among the objective lens optical module, OD3 is an effective optical diameter of an object side surface of the sixth lens, OD1 is an effective optical diameter of the lens closest to the object side among the objective lens optical module, and OD4 is an effective optical diameter of an image side surface of the sixth lens.

8. The optical system as claimed in claim 5, wherein:
the first lens is a biconvex lens with positive refractive power and further comprises another convex surface facing the object side;
the second lens is a biconcave lens with negative refractive power and further comprises another concave surface facing the image side;
the third lens is a meniscus lens with negative refractive power and further comprises a concave surface facing the image side;
the fourth lens is a biconvex lens with positive refractive power and comprises a convex surface facing the object side and another convex surface facing the image side;
the first lens and the second lens are cemented and there is no air gap between the first lens and the second lens, and a combination of the first lens and the second lens is with negative refractive power;
the objective lens optical module further comprises a fifth lens and a prism, wherein the fifth lens is a biconvex lens with positive refractive power, is disposed between the object side and the first lens, and comprises a convex surface facing the object side and another convex surface facing the image side;
the prism is disposed between the fourth lens and the first lens group;
the fifth lens, the first lens, the second lens, the third lens, the fourth lens, and the prism are arranged in order from the object side to the image side along the optical axis;
the eyepiece optical module comprises a fourteenth lens, a fifteenth lens, and a sixteenth lens;
the fourteenth lens is a biconcave lens with negative refractive power and comprises a concave surface facing the object side and another concave surface facing the image side;
the fifteenth lens is a biconvex lens with positive refractive power and comprises a convex surface facing the object side and another convex surface facing the image side;
the sixteenth lens is a biconvex lens with positive refractive power and comprises a convex surface facing the object side and another convex surface facing the image side;
the fourteenth lens and the fifteenth lens are cemented and there is no air gap between the fourteenth lens and the fifteenth lens, and a combination of the fourteenth lens and the fifteenth lens is with positive refractive power; and
the optical system satisfies at least one of following conditions:
9≤fCEEL/fCEEH≤12;
−0.01 mm≤fCEEH×tan(1°/60)<0 mm;
1≤|fOBJ123/fOBJ|≤2;
10≤VdEL2/NdEL2<VdEL1/NdEL1≤45;
85%≤OD2/OD3≤95%;
68%≤OD3/OD1≤75%;
10≤OD1/|OD2−OD33≤30;
6≤OD2/(OD4−OD3)≤15;
wherein fCEEL is a combined effective focal length of a combination of the erector lens optical module and the eyepiece optical module when the optical system is at low zoom ratio, fCEEH is a combined effective focal length of a combination of the erector lens optical module and the eyepiece optical module when the optical system is at high zoom ratio, fOBJ is an effective focal length of the objective lens optical module, fOBJ123 is a combined effective focal length of a combination of the lens closest to the object side, the lens second closest to the object side, and the lens third closest to the object side among the objective lens optical module, VdEL1 is an Abbe number of the lens second closest to the object side among the erector lens optical module, NdEL1 is a refractive index of the lens second closest to the object side among the erector lens optical module, VdEL2 is an Abbe number of the lens third closest to the object side among the erector lens optical module, NdEL2 is a refractive index of the lens third closest to the object side among the erector lens optical module, OD2 is a minimum effective optical diameter among the objective lens optical module, OD3 is an effective optical diameter of an object side surface of the sixth lens, OD1 is an effective optical diameter of the lens closest to the object side among the objective lens optical module, and OD4 is an effective optical diameter of an image side surface of the sixth lens.

9. An optical system comprising:
an objective lens optical module which is with positive refractive power;
an erector lens optical module which is with positive refractive power; and
an eyepiece optical module which is with positive refractive power;
wherein the objective lens optical module, the erector lens optical module, and the eyepiece optical module are arranged in order from an object side to an image side along an optical axis;
wherein the erector lens optical module comprises a first lens group, a second lens group, a third lens group, and a fourth lens group; the second lens group and the third lens group move along the optical axis so that the optical system changes zoom ratio; the first lens group is with positive refractive power and comprises a sixth lens, wherein the sixth lens is a meniscus lens with positive refractive power and comprises a concave surface facing the object side and a convex surface facing the image side;
wherein the second lens group is with positive refractive power;
wherein the third lens group is with positive refractive power;
wherein the fourth lens group is with negative refractive power;
wherein the first lens group, the second lens group, the third lens group, and the fourth lens group are arranged in order from the object side to the image side along the optical axis.

10. The optical system as claimed in claim 9, wherein:
the objective lens optical module comprises a first lens, a second lens, a third lens, and a fourth lens;
the third lens and the fourth lens are cemented and there is no air gap between the second lens and the third lens;
a combination of the third lens and the fourth lens is with positive refractive power; and
the first lens, the second lens, the third lens, and the fourth lens are arranged in order from the object side to the image side along the optical axis.

11. The optical system as claimed in claim 10, wherein:
the first lens is with refractive power and comprises a convex surface facing the image side;
the second lens is with refractive power and comprises a concave surface facing the object side;
the third lens is with refractive power and comprises a convex surface facing the object side; and
the fourth lens is with refractive power.

12. The optical system as claimed in claim 11, wherein:
the second lens group comprises a seventh lens and an eighth lens;
the third lens group comprises a ninth lens and a tenth lens; and
the fourth lens group comprises an eleventh lens, a twelfth lens and a thirteenth lens.

13. The optical system as claimed in claim 12, wherein:
the seventh lens and the eighth lens are cemented and there is no air gap between the seventh lens and the eighth lens, and the seventh lens and the eighth lens move along the optical axis so that the optical system changes zoom ratio;
the ninth lens and the tenth lens are cemented and there is no air gap between the ninth lens and the tenth lens, and the ninth lens and the tenth lens move along the optical axis so that the optical system changes zoom ratio; and
the eleventh lens and the twelfth lens are cemented and there is no air gap between the eleventh lens and the twelfth lens.

14. The optical system as claimed in claim 13, wherein:
the seventh lens is a meniscus lens with positive refractive power;
the eighth lens is a meniscus lens with negative refractive power;
the ninth lens is a meniscus lens with negative refractive power;
the tenth lens is a biconvex lens with positive refractive power and comprises a convex surface facing the object side and another convex surface facing the image side;
the eleventh lens is a biconcave lens with negative refractive power and comprises a concave surface facing the object side and another concave surface facing the image side;
the twelfth lens is a meniscus lens with positive refractive power; and
the thirteenth lens is a meniscus lens with negative refractive power.

15. The optical system as claimed in claim 14, wherein:
the seventh lens comprises a concave surface facing the object side and a convex surface facing the image side;
the eighth lens comprises a concave surface facing the object side and a convex surface facing the image side;
the ninth lens comprises a convex surface facing the object side and a concave surface facing the image side;
the twelfth lens comprises a convex surface facing the object side and a concave surface facing the image side; and
the thirteenth lens comprises a concave surface facing the object side and a convex surface facing the image side.

16. The optical system as claimed in claim 14, wherein:
the first lens is a biconvex lens with positive refractive power and further comprises another convex surface facing the object side;
the second lens is a meniscus lens with negative refractive power and further comprises a convex surface facing the image side;
the third lens is a biconvex lens with positive refractive power and further comprises another convex surface facing the image side;
the fourth lens is a biconcave lens with negative refractive power and comprises a concave surface facing the object side and another concave surface facing the image side;
the first lens and the second lens are cemented and there is no air gap between the first lens and the second lens, and a combination of the first lens and the second lens is with positive refractive power;
the objective lens optical module further comprises a fifth lens and a prism, wherein the fifth lens is a meniscus lens with positive refractive power; is disposed between the second lens and the third lens; and comprises a convex surface facing the object side and a concave surface facing the image side;
the prism is disposed between the fourth lens and the first lens group;
the first lens, the second lens, the fifth lens, the third lens, the fourth lens, and the prism are arranged in order from the object side to the image side along the optical axis;
the eyepiece optical module comprises a fourteenth lens, a fifteenth lens, and a sixteenth lens;
the fourteenth lens is a biconcave lens with negative refractive power and comprises a concave surface facing the object side and another concave surface facing the image side;
the fifteenth lens is a biconvex lens with positive refractive power and comprises a convex surface facing the object side and another convex surface facing the image side;
the sixteenth lens is a biconvex lens with positive refractive power and comprises a convex surface facing the object side and another convex surface facing the image side;
the fourteenth lens and the fifteenth lens are cemented and there is no air gap between the fourteenth lens and the fifteenth lens, and a combination of the fourteenth lens and the fifteenth lens is with positive refractive power; and
the optical system satisfies at least one of following conditions:
9≤fCEEL/fCEEH≤12;
−0.01 mm≤fCEEH×tan(1°/60)<0 mm;
1≤|fOBJ123/fOBJ|≤2;
10≤VdEL2/NdEL2<VdEL1/NdEL1≤45;
85%≤OD2/OD3≤95%;
68%≤OD3/OD1≤75%;
10≤OD1/|OD2−OD3≤30;
6≤OD2/(OD4−OD3)≤15;
wherein fCEEL is a combined effective focal length of a combination of the erector lens optical module and the eyepiece optical module when the optical system is at low zoom ratio, fCEEH is a combined effective focal length of a combination of the erector lens optical module and the eyepiece optical module when the optical system is at high zoom ratio, fOBJ is an effective focal length of the objective lens optical module, fOBJ123 is a combined effective focal length of a combination of the lens closest to the object side, the lens second closest to the object side, and the lens third closest to the object side among the objective lens optical module, VdEL1 is an Abbe number of the lens second closest to the object side among the erector lens optical module, NdEL1 is a refractive index of the lens second closest to the object side among the erector lens optical module, VdEL2 is an Abbe number of the lens third closest to the object side among the erector lens optical module, NdEL2 is a refractive index of the lens third closest to the object side among the erector lens optical module, OD2 is a minimum effective optical diameter among the objective lens optical module, OD3 is an effective optical diameter of an object side surface of the sixth lens, OD1 is an effective optical diameter of the lens closest to the object side among the objective lens optical module, and OD4 is an effective optical diameter of an image side surface of the sixth lens.

17. The optical system as claimed in claim 14, wherein:
the first lens is a biconvex lens with positive refractive power and further comprises another convex surface facing the object side;
the second lens is a biconcave lens with negative refractive power and further comprises another concave surface facing the image side;
the third lens is a meniscus lens with negative refractive power and further comprises a concave surface facing the image side;
the fourth lens is a biconvex lens with positive refractive power and comprises a convex surface facing the object side and another convex surface facing the image side;
the first lens and the second lens are cemented and there is no air gap between the first lens and the second lens, and a combination of the first lens and the second lens is with negative refractive power;
the objective lens optical module further comprises a fifth lens and a prism, wherein the fifth lens is a biconvex lens with positive refractive power, is disposed between the object side and the first lens, and comprises a convex surface facing the object side and another convex surface facing the image side;
the prism is disposed between the fourth lens and the first lens group;
the fifth lens, the first lens, the second lens, the third lens, the fourth lens, and the prism are arranged in order from the object side to the image side along the optical axis;
the eyepiece optical module comprises a fourteenth lens, a fifteenth lens, and a sixteenth lens;
the fourteenth lens is a biconcave lens with negative refractive power and comprises a concave surface facing the object side and another concave surface facing the image side;
the fifteenth lens is a biconvex lens with positive refractive power and comprises a convex surface facing the object side and another convex surface facing the image side;
the sixteenth lens is a biconvex lens with positive refractive power and comprises a convex surface facing the object side and another convex surface facing the image side;
the fourteenth lens and the fifteenth lens are cemented and there is no air gap between the fourteenth lens and the fifteenth lens, and a combination of the fourteenth lens and the fifteenth lens is with positive refractive power; and
the optical system satisfies at least one of following conditions:
9≤fCEEL/fCEEH≤12;
−0.01 mm≤fCEEH×tan(1°/60)<0 mm;
1≤|fOBJ123/fOBJ|≤2;
10≤VdEL2/NdEL2<VdEL1/NdEL1≤45;
85%≤OD2/OD3≤95%;
68%≤OD3/OD1≤75%;
10≤OD1/|OD2−OD33≤30;
6≤OD2/(OD4−OD3)≤15;
wherein fCEEL is a combined effective focal length of a combination of the erector lens optical module and the eyepiece optical module when the optical system is at low zoom ratio, fCEEH is a combined effective focal length of a combination of the erector lens optical module and the eyepiece optical module when the optical system is at high zoom ratio, fOBJ is an effective focal length of the objective lens optical module, fOBJ123 is a combined effective focal length of a combination of the lens closest to the object side, the lens second closest to the object side, and the lens third closest to the object side among the objective lens optical module, VdEL1 is an Abbe number of the lens second closest to the object side among the erector lens optical module, NdEL1 is a refractive index of the lens second closest to the object side among the erector lens optical module, VdEL2 is an Abbe number of the lens third closest to the object side among the erector lens optical module, NdEL2 is a refractive index of the lens third closest to the object side among the erector lens optical module, OD2 is a minimum effective optical diameter among the objective lens optical module, OD3 is an effective optical diameter of an object side surface of the sixth lens, OD1 is an effective optical diameter of the lens closest to the object side among the objective lens optical module, and OD4 is an effective optical diameter of an image side surface of the sixth lens.
